(19) United States
(12) Patent Application Publication
(10) Pub. No.: US 2013/0181656 A1
(43) Pub. Date: Jul. 18, 2013

(54) APPARATUS AND METHOD FOR VOLTAGE CONVERSION

(71) Applicants: Angelo Tortola, Lexington, MA (US); Donald Miffitt, Chelmsford, MA (US)

(72) Inventors: Angelo Tortola, Lexington, MA (US); Donald Miffitt, Chelmsford, MA (US)

(21) Appl. No.: 13/551,569

(22) Filed: Jul. 17, 2012

Related U.S. Application Data
(60) Provisional application No. 61/509,104, filed on Jul. 18, 2011.

(51) Int. Cl. H02J 7/00

(52) U.S. Cl. CPC H02J 7/0054
USPC 320/103

(57) ABSTRACT

Disclosed is a charging device comprising: a DC-to-DC converter for converting electrical power obtained from a battery source into a charging current for transmission to an electronic device; a voltage latch electrically connected to the DC-to-DC converter, the voltage latch for controlling the DC-to-DC converter so as to mitigate oscillation in the battery source; and an output current control electrically connected to the DC-to-DC converter, the output current control for regulating the charging current transmitted to the electronic device.

### CROSS REFERENCE TO RELATED APPLICATION

The present Application is related to Provisional Patent Application entitled “COMPACT MOBILE ELECTRONIC DEVICE CHARGER,” filed 18 Jul. 2011 and assigned filing Ser. No. 61/509,104, incorporated herein by reference in its entirety.

### FIELD OF THE INVENTION

The present invention relates to a system and method for providing a compact and mobile source of electrical power for recharging a mobile electronic device.

### BACKGROUND OF THE INVENTION

Personal mobile electronic devices are in widespread use by consumers. Most such devices operate on an internal rechargeable power source, rather than a disposable battery, and thus require periodic access to an AC charging device. Such AC charging devices typically comprise a transformer that is plugged into an AC power outlet, and a DC output cord with a plug that is connected to the charging port of the device.

However, there are times when the mobile device may be low on electrical power, or has been completely discharged, and the conventional AC charging device has been misplaced or is not otherwise available. In some situations, the user of the mobile electronic device may be in a foreign country, and does not have an AC charging device configured for operation from a local electrical power socket.

What is needed is an apparatus and method for recharging a mobile electronic device when the device AC charger is not available or is incompatible with a locally-available electrical power outlet.

### BRIEF SUMMARY OF THE INVENTION

In one aspect of the present invention, a charging device comprises: a DC-to-DC converter for converting electrical power obtained from a battery source into a charging current for transmission to an electronic device; a voltage latch electrically connected to the DC-to-DC converter, the voltage latch for controlling the DC-to-DC converter so as to mitigate oscillation in the battery source; and an output current control electrically connected to the DC-to-DC converter, the output current control for regulating the charging current transmitted to the electronic device.

In another aspect of the present invention, a charging device comprises: a DC-to-DC converter for converting electrical power obtained from a battery source into a charging current for transmission to an electronic device, the DC-to-DC converter including a first microcircuit functioning as a step-down DC-to-DC regulator; a voltage latch electrically connected to the DC-to-DC converter, the voltage latch including a second microcircuit configured as a comparator; and an output current control electrically connected to the DC-to-DC converter, the output current control including a third microcircuit functioning as a current sense monitor.

In still another aspect of the present invention, a method for recharging a rechargeable electronic device comprises: obtaining a DC-to-DC converter, a voltage latch electrically attached to the DC-to-DC converter, and an output current control connected to an output of the DC-to-DC converter; electrically connecting a battery source to an input of the DC-to-DC converter; and electrically connecting the output current control to the rechargeable electronic device.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is a functional block diagram of a charging device for a mobile electronic device, the charging device including a DC-to-DC converter module, a voltage latch module, an output current control module, and an optional delay timer, the charging device electrically connected between a battery and the mobile electronic device, in accordance with an aspect of the present invention;

FIG. 2 is an alternate embodiment of the charging device of FIG. 1, including an ESD protection component, a reverse voltage protection component, and a battery indicator light;

FIG. 3 is an alternate embodiment of the charging device of FIG. 2, including input battery terminals and an output connector for electrically connecting to the mobile electronic device;

FIG. 4 is a flow chart illustrating a method of charging a mobile electronic device, in accordance with an aspect of the present invention;

FIG. 5 is a detail view of the DC-to-DC convertor module of FIG. 1;

FIG. 6 is a detail view of the voltage latch module and the delay timer module of FIG. 1;

FIG. 7 is a detail view of a battery indicator light, as used in the charging device of FIG. 2;

FIG. 8 is a detail view of the ESD protection component of FIG. 2;

FIG. 9 is a detail view of the reverse voltage protection component of FIG. 2;

FIG. 10 is a detail view of the output current control module of FIG. 1;

FIG. 11 is a diagrammatical isometric view of a charge key containing one of the charging devices of FIGS. 1-3, in accordance with an aspect of the present invention; and

FIG. 12 is an isometric rendering of an embodiment of a charge key with an end cap, containing one of the charging devices of FIGS. 1-3 and configured in a stylized key-shape;

FIG. 13 is a view of the charge key of FIG. 11, with the end cap of FIG. 12 installed, and showing the battery indicator light of FIG. 7; and

FIG. 14 is an isometric rendering of an alternate embodiment of a charge key with an end cap, containing one of the charging devices of FIGS. 1-3 and configured as a geometric solid.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

The disclosed compact charging device includes a DC-to-DC convertor that can be adapted for a variety of input voltages, as provided by a suitable battery source, and output voltages, as required by a particular mobile electronic device. The disclosed compact charging device can easily be carried on a user's person, or attached to a keychain, and can make use of readily available battery power sources to recharge the mobile electronic device.

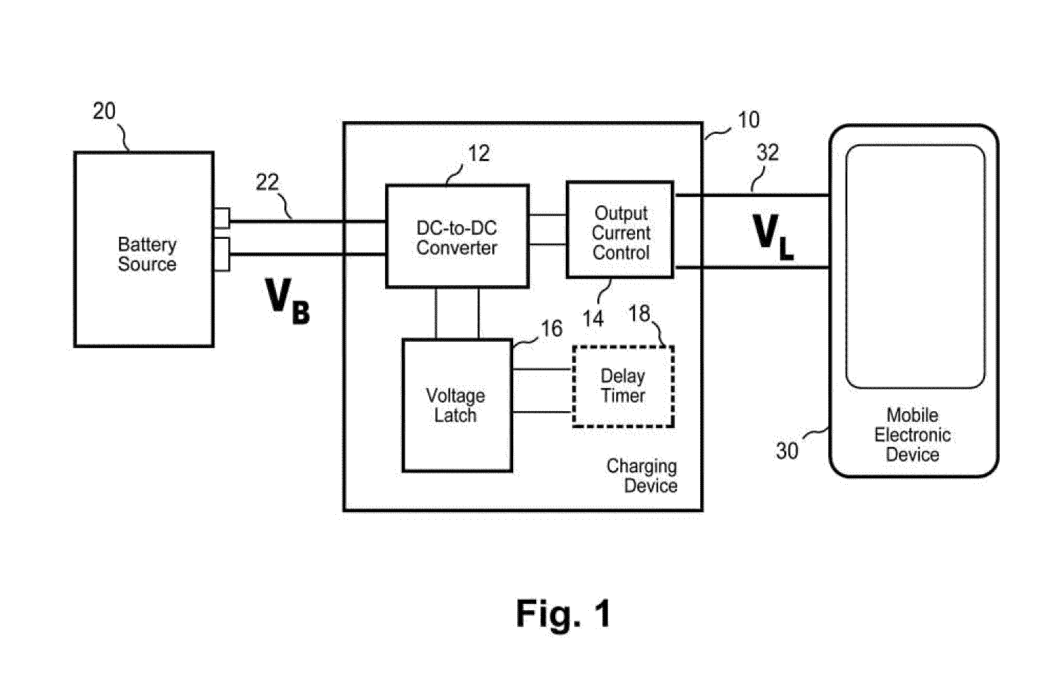

There is shown in FIG. 1 a compact charging device 10, in accordance with the present invention. The charging device 10 comprises a DC-to-DC converter 12, a voltage latch 16, an optional delay timer 18, and an output current control 14. A battery source 20 may provide an input voltage VB to the DC-to-DC converter 12 in the charging device 10 via a pair of input leads 22. The voltage latch 16 may be connected to the DC-to-DC converter 12 so as to mitigate or prevent oscillation in the battery source 20 during operation of the compact charging device 10. The delay timer 18 may be electrically connected to the voltage latch 16 to control the response of the voltage latch 16 to the initial connection of the input voltage VB to the DC-to-DC converter 12, as explained in greater detail below.

The DC-to-DC converter 12 in the charging device 10 may output a charging voltage of VL to a mobile electronic device 30 via a pair of output leads 32. It should be understood that, while the disclosed charging device 10 may be particularly suitable for use with the mobile electronic device 30, the present invention is not limited to use with mobile electronic devices, and can be configured to operate with essentially any electronic device powered with an internal rechargeable power source. The output current control 14 functions to regulate the amount of charging current transmitted to a rechargeable battery (not shown) in the mobile electronic device 30. In an exemplary embodiment, the charging device 10 may be configured to provide a charging voltage, within a pre-specified range of voltages, to a SMARTPHONE, an ANDROID, an IPHONE, a BLACKBERRY, an ITOUCH, various types of Wi-Fi mobile devices, and various types of TABLETS, such as an IPAD.

In an exemplary embodiment, the output voltage VL may be about five volts for most mobile electronic devices, and may be a voltage level other than five volts for products manufactured by Apple Corporation, for example. As can be appreciated by one skilled in the art, the optimal current level provided by the charging device 10 may vary from one device to another. Accordingly, the output current control 14 may be configured so as to provide an optimal charge current for a specific mobile electronic device. It can be appreciated by one skilled in the relevant art that the specific components and component values used in the charging device 10 are a function of the input voltage VB and the output voltage VL.

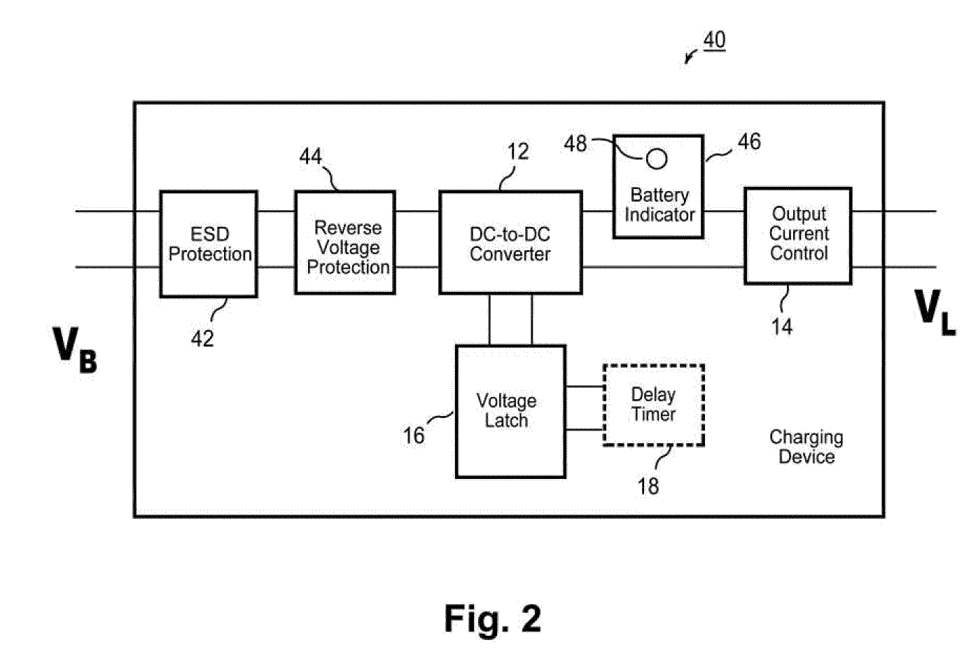

In an exemplary embodiment, shown in FIG. 2, a charging device 40 comprises the DC-to-DC converter 12, the voltage latch 16, the output current control 14, and may include the delay timer 18. In addition, the charging device 40 may further comprise one or more of an ESD protection component 42, a reverse voltage protection component 44, and a battery indicator circuit 46 including a battery indicator light 48. The ESD protection component 42 may be directly connected to the input leads 22 so as to protect the DC-to-DC converter 12 from ambient static charges. The reverse voltage protection component 44 may be electrically connected between the input voltage VB and the DC-to-DC converter 12 so as to protect the DC-to-DC converter 12 in the event that a user incorrectly reverses connection of the battery source 20 to the charging device 40.

The battery indicator circuit 46 may be electrically connected between the DC-to-DC converter 12 and the output current control 14 to provide an indication, via the indicator light 48, as to the status of the charging operation. In an exemplary embodiment, the indicator light 48 illuminates while the battery source 20 is charging the mobile electronic device 30. When the indicator light 48 ceases illumination, this condition may serve to inform the user that the installed battery source 20 has been depleted. Accordingly, the depleted battery source 20 can be removed and replaced with another battery source 20, if the rechargeable battery in the mobile electronic device 30 has not been fully recharged. The replacement battery source 20 can be electrically connected to the charging device 40 so as to continue or complete the recharging process.

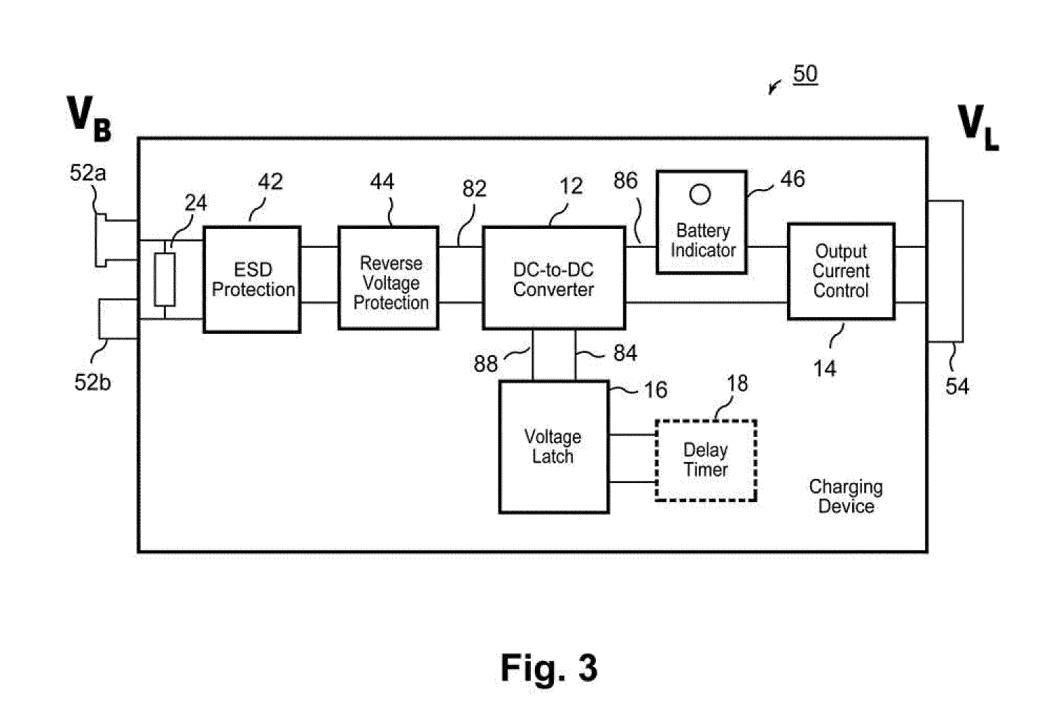

In an exemplary embodiment, shown in FIG. 3, a charging device 50 may comprise the DC-to-DC converter 12, the voltage latch 16, the optional delay timer 18, the output current control 14, the optional ESD protection component 42, the optional reverse voltage protection component 44, the optional battery indicator 46, a set of battery terminals such as miniature snap terminals 52a, 52b, and an electronic device connector 54. A bleeder resistor 24 may be provided across the miniature snap terminals 52a, 52b to be used in conjunction with the delay timer 18, as described in greater detail below.

The miniature snap terminals 52a, 52b may be used, for example, when the battery source 20 comprises a nine-volt battery in accordance with ANSI-1604A or IEC-6LR61 standards. A nine-volt battery based on a zinc-magnesium dioxide chemical system can provide a charge of from about 300 mAh (at a discharge rate of 500 to 1000 mA). A plurality of “AA” batteries may also be used, in place of the nine-volt battery, where each AA battery can provide a charge output of about 1.5 volts at about 2500 mAh. It should be understood that, if AA batteries are used, battery terminals (not shown) other than the snap terminals 52a, 52b could be used on the device housing, or an adapter (not shown) could be electrically connected between the snap terminals 52a, 52b and a battery holder containing the AA batteries. It can be appreciated by one skilled in the art that a typical mobile electronic device 30 may require a charging current of about 500 mA at a charge level of about five-volts.

In an exemplary embodiment, the electronic device connector 54 may comprise a micro-USB connector adapted to mate with the micro-USB receptacle in a SMARTPHONE, for example. In an alternative embodiment, the electronic device connector 54 may comprise a 30-pin, I/O plug with latches, when the charging device 50 is configured for use with one or more products manufactured by the Apple Corporation.

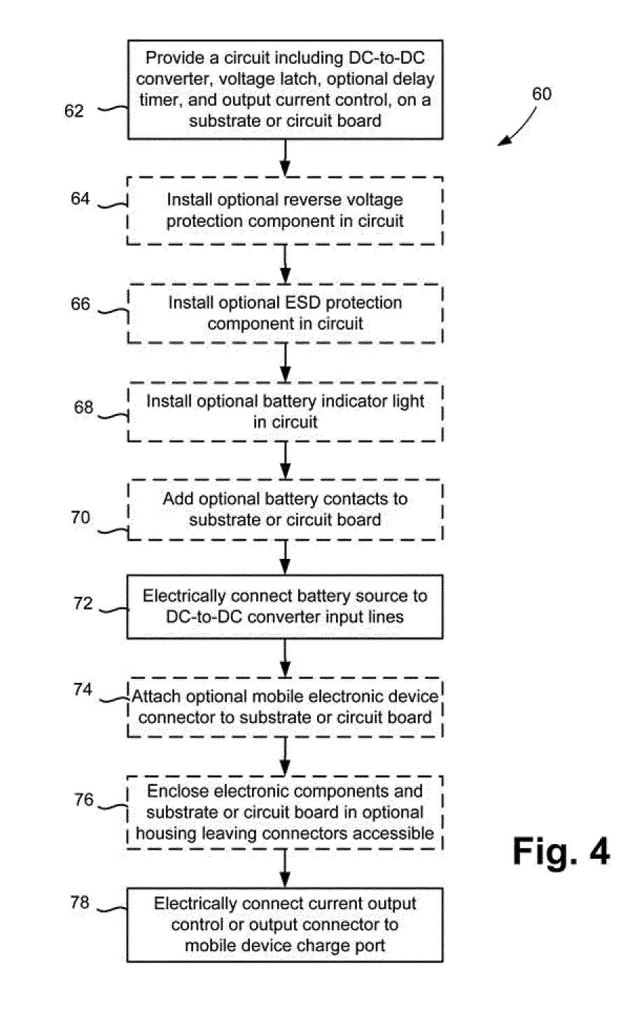

Use of the charging devices 10, 40, 50 with the mobile electronic device 30 may be described with reference to a flow diagram 60, in FIG. 4. The user may obtain and electrically interconnect the DC-to-DC converter 12, the voltage latch 16, the delay timer 18, and the output current control 14, in accordance with FIGS. 1-3, at step 62. One or more of the DC-to-DC converter 12, the voltage latch 16, the delay timer 18, and the output current control 14 may be mounted on a substrate or circuit board (not shown) to form a basic voltage conversion circuit, as is well-known in the relevant art.

The optional ESD protection component 42 may also be mounted on the substrate if desired, at step 64. The optional reverse voltage protection component 44 may also be included in the charging device circuit, at step 66. The optional battery indicator circuit 46 may be integrated into the circuit on the substrate, at step 68. The set of miniature snap terminals 52a, 52b may be electrically attached to the substrate at the input side of the charging circuit, at step 70.

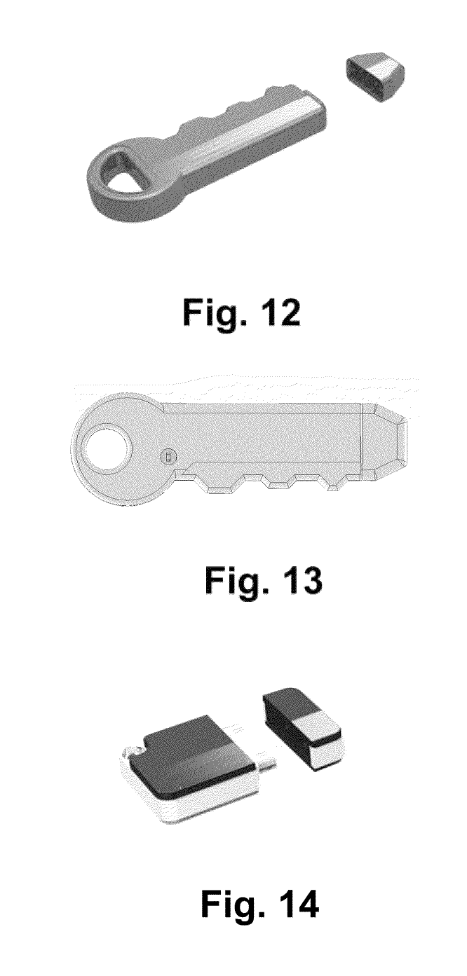

The battery source 20 may be attached directly to the charging circuit, or to the set of miniature snap terminals 52a, 52b, at step 72, so as to provide electrical power to the DC-to-DC converter 12. The appropriate electronic device connector 54 may be selected for compatibility with the mobile electronic device 30, and electrically attached to the output leads 32, at step 74. A housing 92 (see FIGS. 11-14) may be provided to enclose and secure the substrate and electronic components, at step 76, while leaving the electronic device connector 54 sufficiently exposed to allow insertion into a charging port of the mobile electronic device 30. The housing 92 may include a cap (see FIGS. 12-14) to fit over the electronic device connector 54 for protection against dirt and moisture. The power output of the DC-to-DC converter 12 may thus be provided to the mobile electronic device 30 via the output current control 14 and the electronic device connector 54, at step 78.

As can be appreciated by one skilled in the art, the charging devices 10, 40, 50 are thus (i) small and compact for placement on a user's keychain, for example, when enclosed in an appropriate housing, such as shown in FIGS. 11-14 below, (ii) configured to be used with battery sources readily-available world-wide, and (iii) of relatively low cost as the charging devices 10, 40, 50 do not require battery storage compartments, as it is not necessary that the battery source 20 be retained in any of the charging devices 10, 40, 50 between charging sessions. In an exemplary embodiment, the battery source 20 comprises a nine-volt battery configured in a rounded rectangular package with male and female snap connectors at one end configured for mating with the set of miniature snap terminals 52a, 52b. Alternatively, the battery voltage VB supplied to the compact charging device 10, 40, 50 may be greater or less than nine volts, and accordingly, may utilize one or more commercially-available battery products for providing charging power, other than a nine-volt battery.

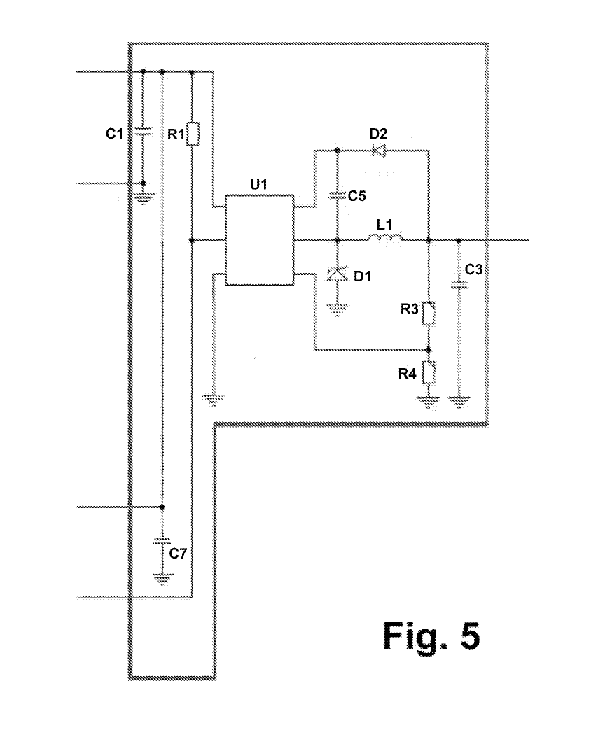

In an exemplary embodiment, the DC-to-DC converter 12, shown in FIG. 5, may comprise a voltage converter microcircuit (U1), or equivalent electronic components, the microcircuit U1 commercially available as a step-down DC-to-DC regulator MCP16301 manufactured by Microchip Technology Inc. of Chandler, AZ. Power from the battery source 20 may be provided to an input voltage pin of the voltage converter microcircuit U1 via an input line 82. An enable logic-level signal may be provided to an EN pin via an enable line 84 to enable or disable the voltage converter microcircuit U1. Output voltage is provided via a power line 86 from a SW pin on the voltage converter microcircuit U1, where a switch node may also include an inductor (L1) and a Schottky diode (D1).

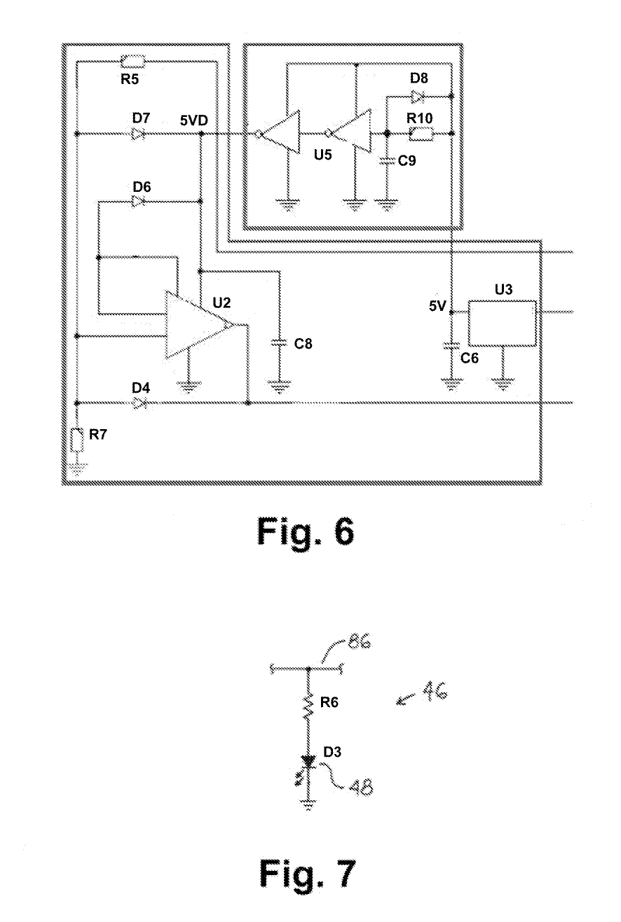

In an exemplary embodiment, the voltage latch 16, shown in FIG. 6, may comprise (i) a microcircuit (U2), or equivalent electronic components, the microcircuit U2 commercially available as a comparator with integrated reference voltage MCP65R46T-2402E/CHY, and (ii) a microcircuit (U3), or equivalent electronic components, the microcircuit U3 commercially available as a voltage regulator MCP1702, both microcircuits manufactured by Microchip Technology Inc. of Chandler, Ariz. The output of the microcircuit U2 may provide the enable signal transmitted to the DC-to-DC converter 12 via the enable line 84. The microcircuit U3 may receive an input voltage signal from the battery source 20 via an input voltage line 88.

The microcircuit U3, here shown as a five-volt regulator, functions to convert a voltage (VIN) at the input voltage VB level (e.g., nine volts) into a voltage (VOUT) at the output voltage VL level (e.g., five volts). The delay timer 18 functions to impose a time delay before the output voltage (VOUT) of the microcircuit U3 is provided to the microcircuit U2 in the voltage latch 16. In an exemplary embodiment, a delay timer microcircuit (U5), or equivalent electronic components, may be used in the delay timer 18 to enable a time interval delay of about 0.5 seconds. The microcircuit U5 may comprise a 74LVC2G14 dual-inverting Schmidt trigger with five-volt tolerant inputs, such as may be available from NXP Semiconductors of San Jose, Calif. As described above, the Schmidt trigger component may function to selectively disable the EN (enable) pin on the DC-to-DC converter 12 for the pre-determined period of time set by the delay timer 18 time delay.

Under some operating conditions, when a battery is inserted into battery terminals, such as the miniature snap terminals 52a, 52b, the physical action may generate electrical noise that causes voltage converter microcircuit U1 in the DC-to-DC converter 12 to latch “OFF.” The purpose of the delay timer 18 is to protect the DC-to-DC converter 12 against such electrical noise by providing an initial time interval during which the enable port (EN) on the voltage converter microcircuit U1 is disabled, and consequently, will not respond to electrical noise as an input signal. The delay timer 18 may be reset after the bleeder resistor 24 has caused a discharge of capacitors C1 and C7 in the DC-to-DC converter 12.

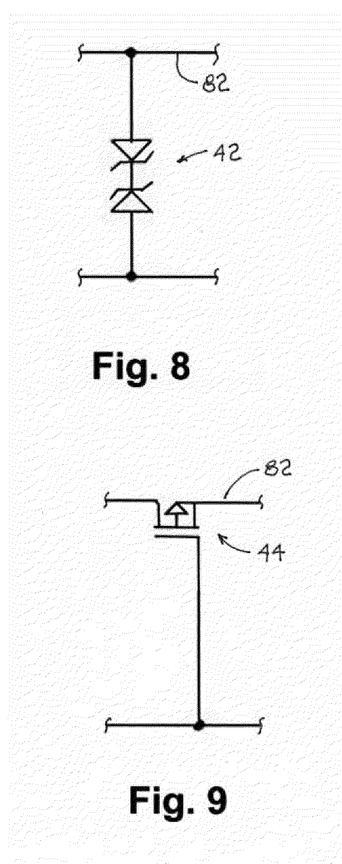

In an exemplary embodiment, the battery indicator 46, shown in FIG. 7, may comprise a resistor (R6) on the power line 86, in series with a light-emitting diode (D3) functioning as the battery indicator light 48. As shown in FIG. 8, the ESD protection component 42 may comprise a bi-directional power Zener diode voltage suppressor, or equivalent component, on the input line 82, the diode commercially available as 1SMA1OCAT3G manufactured by ON Semiconductor of Phoenix, Ariz.

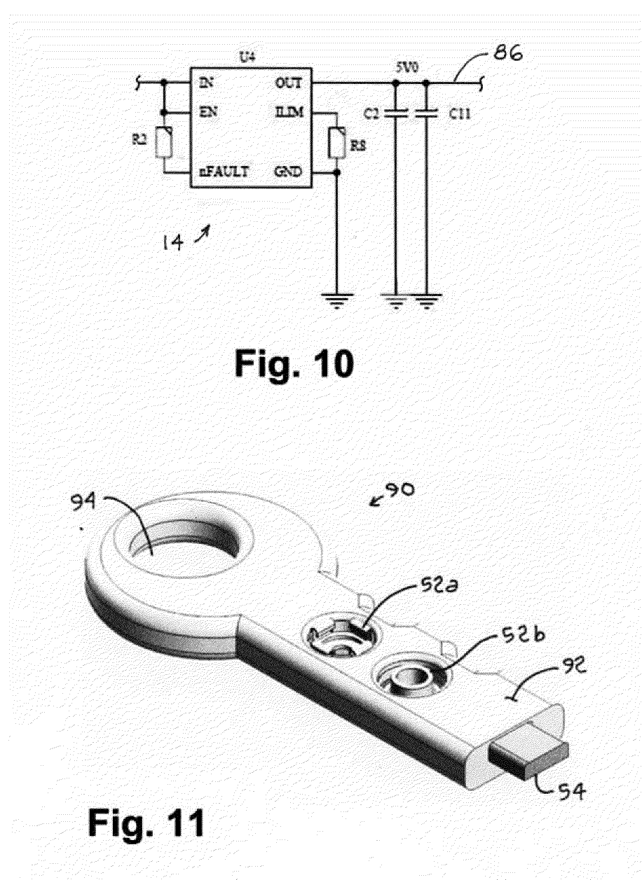

The reverse voltage protection component 44 may comprise a p-channel FET on the input line 82, as shown in FIG. 9, the FET commercially available as FDN308P manufactured by Fairchild Semiconductor of San Jose, Calif., or an equivalent electronic component. In an exemplary embodiment, the output current control module 14, shown in FIG. 10, may comprise a microcircuit (U4) or equivalent electronic components, on the power line 86, with shunt resistors, and with capacitance to ground at the microcircuit output, the microcircuit U4 commercially available as a current sense monitor ZXCT1009FTA, manufactured by Diodes Incorporated of Dallas, Tex.

In an exemplary embodiment, any of the compact charging devices 10, 40, 50 may be fabricated on a suitable substrate or circuit board (not shown) and enclosed in the housing 92, shown in FIG. 11. The housing 92 may be fabricated from a rugged, moisture-resistant material such as a high-impact plastic, to form a compact “charge key” device 90. The set of miniature snap terminals 52a, 52b are exposed in the housing 92 so as to enable attachment of the nine-volt battery.

It can be appreciated that the configuration of the housing 92 physically retains the battery source outside the housing 92. That is, the housing 92 does not include a battery compartment. Accordingly, because ambient air can provide cooling to the battery source, the heat buildup in the battery source is at a lesser rate than if the battery source were enclosed in a battery compartment. This feature allows the user to remove the battery source from the set of miniature snap terminals 52a, 52b when the battery indicator light 48 goes out, allow the battery source to cool, and then re-install the battery source to more completely drain off any charge that may be remaining in the battery source.

The electronic device connector 54, here configured as a micro-USB connector, extends from one end of the charge key device 90, and is thus accessible to allow for insertion into a charge port of the mobile electronic device 30. An optional cap (shown in FIG. 12) may be provided to fit over the electronic device connector 54. In an alternative embodiment (not shown), the housing 92 may be configured so as to allow the electronic device connector 54 to be retracted into the housing 92.

An opening 94 may be provided in the charge key device 90 to allow for attachment to a key ring, for convenient access by a user. In an alternative embodiment, shown in FIG. 12, a charge key device 100 may include a cap 102 for covering and protecting the electronic device connector 54 (not shown). The charge key device 100 may comprise any of the charging devices 10, 40, 50 disclosed above. It can be appreciated that the cap 102 may also be used on the charge key device 90, as shown in FIG. 13. The battery indicator light 48 may be located in a convenient position on the respective housing of either the charge key device 90, as shown, or the charge key device 100, such that the charging device user can monitor the charging process.

It should be understood that the present invention is not limited to a housing 92, shown in FIG. 11, having the size and shape of a key. For example, a charge key device 104 may have the general shape of a geometric solid, such as the parallelepiped configuration shown in FIG. 14. Other shapes and sizes can be used for configuring a housing for enclosing any of the charging devices 10, 40, 50. A geometrically-compatible cap 106 may be provided with the charge key device 104 to cover the electronic device connector 54 (not shown). The charge key device 104 may comprise any of the charging devices 10, 40, 50 described above, and may also include the battery indicator light 48 on the device housing.

It can be appreciated that the electronic components used in any of the charging devices 10, 40, 50 can be mounted to a substrate of essentially any shape and configuration, limited only by circuitry requirements. Preferably, the charging device battery connectors and electronic device connector are positioned on the substrate or circuit board so as to allow a user external access to the battery connectors, so as to retain the battery outside the device housing, and so as to allow the charging device user to access the electronic device connector for insertion into an electronic device.

It can be appreciated that the electronic component substrate used for any of the charging devices 10, 40, 50 may be enclosed in a housing of essentially any size and shape, as may be envisioned by a product designer. For example, the sizes and shapes available for housing miniature external hard drives, commonly referred to as “thumb” drives or “travel” drives, can be adapted for use with any of the charging devices 10, 40, 50. A miniature external hard drive similarly includes a protruding or retractable electronic device connector, such as a USB connector, and is similar in size to any of the charging devices 10, 40, 50. Accordingly, the array of housing designs adapted for use with miniature external hard drives may be appropriated for use with any of the charging devices 10, 40, 50.

It is to be understood that the description herein is exemplary of the invention only and is intended to provide an overview for the understanding of the nature and character of the disclosed illumination systems. The accompanying drawings are included to provide a further understanding of various features and embodiments of the method and devices of the invention which, together with their description serve to explain the principles and operation of the invention.

What is claimed is:

1. A charging device suitable for charging an electronic device from a battery source, said voltage converter comprising:
a DC-to-DC converter for converting electrical power obtained from the battery source into a charging current for transmission to the electronic device;
a voltage latch electrically connected to said DC-to-DC converter, said voltage latch for controlling said DC-to-DC converter so as to mitigate oscillation in the battery source; and
an output current control electrically connected to said DC-to-DC converter, said output current control for regulating said charging current transmitted to the electronic device.

2. The charging device of claim 1 further comprising a set of battery terminals electrically connected to an input of said DC-to-DC converter, said set of battery terminals for providing an electrical connection between said DC-to-DC converter and the battery source during a charging operation.

3. The charging device of claim 2 further comprising an electrostatic discharge protection component electrically connected between said battery terminals and said DC-to-DC converter.

4. The charging device of claim 2 further comprising a reverse voltage protection component electrically connected between said battery terminals and said DC-to-DC converter.

5. The charging device of claim 2 further comprising a delay timer electrically attached to said voltage latch, said delay timer for delaying a latching function of said voltage latch.

6. The charging device of claim 1 further comprising an electronic device connector electrically connected to said DC-to-DC converter, said electronic device connector for providing removable electrical connection of said voltage converter to the electronic device.

7. The charging device of claim 1 further comprising a battery indicator light electrically connected between said DC-to-DC converter and said output current control.

8. The charging device of claim 1 further comprising a housing for enclosing one or more of: said DC-to-DC converter, said voltage latch, and said output current control.

9. A charging device suitable for charging an electronic device from a battery source, said voltage converter comprising:
a DC-to-DC converter for converting electrical power obtained from the battery source into a charging current for transmission to the electronic device, said DC-to-DC converter including a first microcircuit functioning as a step-down DC-to-DC regulator;
a voltage latch electrically connected to said DC-to-DC converter, said voltage latch including a second microcircuit configured as a comparator; and
an output current control electrically connected to said DC-to-DC converter, said output current control including a third microcircuit functioning as a current sense monitor.

10. The charging device of claim 9 further comprising a set of miniature snap terminals for providing removable electrical connection of said charging device to the battery source.

11. The charging device of claim 9 further comprising at least one of a 30-pin, I/O connector and a micro-USB connector, said at least one connector for providing removable electrical connection of said charging device to the electronic device.

12. The charging device of claim 9 further comprising an indicator light functioning to indicate whether charging current provided by the battery source has been depleted.

13. The charging device of claim 9 further comprising a field effect transistor electrically connected to an input of said DC-to-DC converter, said field effect transistor functioning to provide reverse voltage protection to said DC-to-DC converter.

14. The charging device of claim 9 further comprising a housing configured to retain said DC-to-DC converter, said voltage latch, and said output current control within said housing, said housing further configured to retain the battery source outside said housing.

15. The charging device of claim 9 further comprising a dual-inverting Schmidt trigger with five-volt tolerant inputs electrically attached to said voltage latch, said Schmidt trigger functioning to selectively disable an enable port on said DC-to-DC converter for a pre-determined period of time.

16. A method of recharging a rechargeable electronic device, said method comprising the steps of:
obtaining a DC-to-DC converter, electrically connecting a voltage latch to said DC-to-DC converter, electrically connecting a delay timer to said voltage latch, and electrically connecting an output current control to an output of said DC-to-DC converter;
electrically connecting a battery source to an input of said DC-to-DC converter; and
electrically connecting said output current control to the rechargeable electronic device.

17. The method of claim 16 further comprising the step of electrically attaching electrostatic discharge protection between said DC-to-DC converter and said battery source.

18. The method of claim 16 further comprising the step of electrically attaching a battery indicator between said DC-to-DC converter and output current control.

19. The method of claim 16 wherein said battery source comprises a nine-volt battery configured in a rounded rectangular package and having male and female miniature snap electrical connectors.

20. The method of claim 16 further comprising the step of mounting said DC-to-DC converter, said voltage latch, said delay timer, and said output current control on a circuit board, and securing said circuit board in a housing.
